(19) United States
(12) Patent Application Publication
(10) Pub. No.: US 2016/0092019 A1
(43) Pub. Date: Mar. 31, 2016

(54) SCANNING METHOD AND DEVICE OF A SINGLE LAYER CAPACITIVE TOUCH PANEL

(71) Applicant: ELAN MICROELECTRONICS CORPORATION, Hsinchu (TW)

(72) Inventors: Jung-Shou Huang, Zhubei City (TW); Chia-Mu Wu, Taipei City (TW)

(73) Assignee: ELAN MICROELECTRONICS CORPORATION, Hsinchu (TW)

(21) Appl. No.: 14/848,380

(22) Filed: Sep. 9, 2015

Related U.S. Application Data
(60) Provisional application No. 62/055,660, filed on Sep. 26, 2014.

(30) Foreign Application Priority Data
Nov. 27, 2014 (TW) 103141120

(51) Int. Cl. G06F 3/041; G06F 3/044

(52) U.S. Cl. CPC G06F 3/0416; G06F 3/044; G06F 2203/04107

(57) ABSTRACT

A scanning method and device of a single layer capacitive touch panel has a self and mutual capacitive scanning procedures. The single layer capacitive touch panel has multiple electrode groups and shielding units respectively formed between the two corresponding adjacent electrode groups. When the self capacitive scanning procedure is executed, a first driving signal is outputted to each of the electrode groups and each of the shielding units. A self capacitive sensing signal of the driven electrode group is received after then. When the mutual capacitive scanning procedure is executed, a second driving signal is outputted to each of the electrode group and each of the shielding unit is connected to a ground. A mutual capacitive sensing signal from each of the driven electrode groups is received after then. Therefore, the self capacitance value of the self capacitive sensing signal is not increased greatly since the shielding units are not connected to the ground.

### CROSS-REFERENCE TO RELATED APPLICATIONS

This application claims the benefit of U.S. provisional application filed on Sep. 26, 2014 and having application Ser. No. 62/055,660, the entire contents of which are hereby incorporated herein by reference.

This application is based upon and claims priority under 35 U.S.C. 119 from Taiwan Patent Application No. 103141120 filed on Nov. 27, 2014, which is hereby specifically incorporated herein by this reference thereto.

### BACKGROUND OF THE INVENTION

1. Field of the Invention

The present invention is related to a scanning method of a capacitive touch panel, and more particularly to a scanning method and device of a single layer capacitive touch panel.

2. Description of the Prior Arts

With reference to FIG. 5, a single layer capacitive touch panel 50 is connected to a mutual capacitive scanning circuit 60. The single layer capacitive touch panel 50 has multiple electrode groups 51. Each of the electrode groups 51 has multiple driving electrodes 511 and multiple sensing electrodes 513. The multiple driving electrodes 511 are respectively connected to multiple leading lines 512. The leading lines 512 are further connected to the mutual capacitive scanning circuit 60, so that the mutual capacitive scanning circuit 60 is electrically connected to the driving electrodes 511 through the leading lines 512. The leading lines 512 are formed on the single layer capacitive touch panel 50 and are arranged in parallel. With further reference to FIG. 6, a driving signal is outputted to the driving electrode 511 through the leading line 512 when the mutual capacitive scanning circuit 60 executes a mutual capacitive scanning procedure. After then, a mutual capacitive sensing signal from the sensing electrode 513 is received. At the time, a touch object 40 touches the driven driving electrode 511 and a mutual capacitance value of the received mutual capacitive sensing signal is Cf+Cp , wherein Cf is a coupling capacitance between the touch object 40 and the driving electrode 511 and Cp is a coupling capacitance between the driving electrode 511 and sensing electrode 513. A position of the touch object 40 is identified according to the mutual capacitance value. However, the received mutual capacitive sensing signal is interfered during the mutual capacitive scanning procedure, since the leading lines 512 are arranged in parallel. To overcome this drawback, a shielding line 52 is formed between the two corresponding adjacent leading lines 512, and each shielding line 52 is connected to a ground GND.

The single layer capacitive touch panel 50 may be further connected to a self capacitive scanning circuit (not shown) but a receiving circuit of the self capacitive scanning circuit has to be changed. With reference to FIG. 7, a self capacitive sensing signal is received from a leading line 512 after a driving signal is outputted to a driving electrode 511 through the same leading line 512 during a self capacitive scanning procedure. A self capacitance value of the self capacitive sensing signal is Cf+Cs+Cp′, wherein Cs is a capacitance between the driving electrode 511 and the ground GND, and Cp′ is a coupling capacitance between the leading line 512 and the shielding line 52 connected to the ground GND. If the single layer capacitive touch panel 50 does not have shielding lines 52, the self capacitance value of the self capacitive sensing signal will be Cf+Cs. The self capacitance value of the single layer capacitive touch panel 50 with shielding lines 52 is greater than that of the single layer capacitive touch panel 50 without shielding lines 52, so that the receiving circuit of the self capacitive scanning circuit for the single layer capacitive touch panel 50 with shielding lines 52 has to be changed to use larger compensation capacitances. In addition, the larger compensation capacitances formed in an integrated circuit occupied a larger layout area of the integrated circuit and a manufacturing cost is increased. Therefore, a combination of self and mutual capacitive scanning circuits for the single layer capacitive touch panel is not good enough.

To overcome the shortcomings, the present invention provides a scanning method and device of a single layer capacitive touch panel to mitigate or obviate the aforementioned problems.

### SUMMARY OF THE INVENTION

The objective of the present invention is to provide a scanning method and device of a single layer capacitive touch panel to correctly identify a position of a touch object during a self capacitive scanning procedure or a mutual capacitive scanning procedure. In addition, a receiving circuit of a self capacitive scanning circuit is not changed.

To achieve the objective, the single layer capacitive touch panel has multiple electrode groups and multiple shielding units, each of which is formed between the two corresponding adjacent electrode groups. A controller is electrically connected to the electrode groups and the shielding units, and each of the electrode groups has n driving electrodes, n leading lines respectively connected to the n driving electrodes and at least one sensing electrode. Each of the at least one sensing electrodes is formed adjacent to the n corresponding driving electrodes. The scanning method has a self capacitive scanning procedure and a mutual capacitive scanning procedure.

When the self capacitive scanning procedure is executed, the controller outputs a first driving signal to each of the electrode groups and each of the shielding units at the same time, and then receives a self capacitive sensing signal from each of the driven electrode groups. When the mutual capacitive scanning procedure is executed, the controller outputs a second driving signal to each of the electrode groups, and connects each of the shielding units to a ground, and then receives a mutual capacitive sensing signal from each of driven electrode groups.

Since the shielding units are connected to the ground, the driven electrode groups are not interfered with each other during the mutual capacitive scanning procedure. During the self capacitive scanning procedure, the shielding units are not connected to the ground and the first driving signal is outputted to the shielding unit and the driving electrode, which is going to be driven at the same time, so that the self capacitance value of the self capacitive sensing signal is not increased greatly. Therefore, the present invention provides a scanning method of the single layer capacitive touch panel to correctly identify a position of a touch object during a self capacitive scanning procedure or a mutual capacitive scanning procedure. In addition, a receiving circuit of a self capacitive scanning circuit for implementing the self capacitive scanning procedure is not changed.

To achieve the objective, the scanning device of a single layer capacitive touch panel has a substrate and a controller. The substrate has multiple electrode groups and multiple shielding units. Each of the shielding unit is formed between the two corresponding adjacent electrode groups and each of the electrode groups has n driving electrode, n leading lines arranged in parallel and respectively connected to the n driving electrodes and at least one sensing electrode. The controller is electrically connected to the electrode groups and the shielding units and has a self capacitive scanning procedure. When the controller executes the self capacitive scanning procedure, the controller outputs a first driving signal to each of the electrode groups and each of the shielding units at the same time, and then receives a self capacitive sensing signal from each of the driven electrode groups.

When the controller of the scanning device executes the self capacitive scanning procedure, the shielding units are not connected to the ground and the first driving signal are output to the electrode group, which is going to be driven, and the shielding unit adjacent to the electrode group at the same time. Accordingly, a coupling capacitance between the grounded shielding unit and the leading line of the driven electrode is not formed. Therefore, the present invention provides a scanning device of the single layer capacitive touch panel to correctly identify a position of a touch object during a self capacitive scanning procedure. In addition, a receiving circuit of a self capacitive scanning circuit is not changed.

Other objectives, advantages and novel features of the invention will become more apparent from the following detailed description when taken in conjunction with the accompanying drawings.

### BRIEF DESCRIPTION OF THE DRAWINGS

FIG. 1 is a structural schematic drawing of a first embodiment of a signal layer capacitive touch panel in accordance with the present invention;

FIG. 2 is a functional block diagram of a controller in accordance with the present invention;

FIG. 3-1A is a driving time sequence diagram of a first type of a self capacitive scanning procedure executed by the controller in accordance with the present invention;

FIG. 3-2A is a receiving time sequence diagram corresponding to FIG. 3-1A;

FIG. 3-1B is driving time sequence diagram of a second type of a self capacitive scanning procedure executed by the controller in accordance with the present invention;

FIG. 3-2B is a receiving time sequence diagram corresponding to FIG. 3-1B;

FIG. 3-1C is driving time sequence diagram of a third type of a self capacitive scanning procedure executed by the controller in accordance with the present invention;

FIG. 3-2C is a receiving time sequence diagram corresponding to FIG. 3-1C;

FIG. 4 is a driving and receiving sequence diagram of a mutual capacitive scanning procedure executed by the controller in accordance with the present invention;

FIG. 5 is a structural schematic diagram of a conventional signal layer capacitive touch panel and a mutual capacitive scanning circuit in accordance with prior art;

FIG. 6 is a partial and cross sectional view of FIG. 5 during a mutual capacitive scanning procedure; and

FIG. 7 is a partial and cross sectional view of FIG. 5 during a self capacitive scanning procedure.

### DETAILED DESCRIPTION OF THE PREFERRED EMBODIMENTS

The present invention provides a scanning method and device of a signal layer capacitive touch panel to obtain an accurate sensing capacitance under different scanning procedures and an accuracy of identifying touch object is increased. Using different embodiments describes details of the present invention.

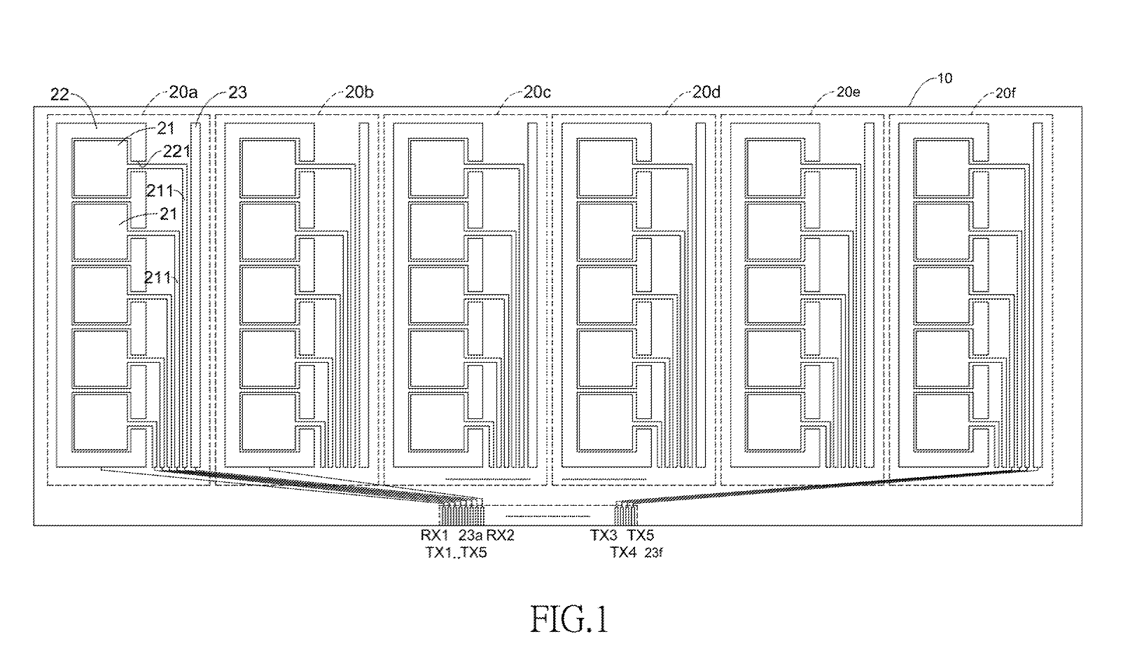

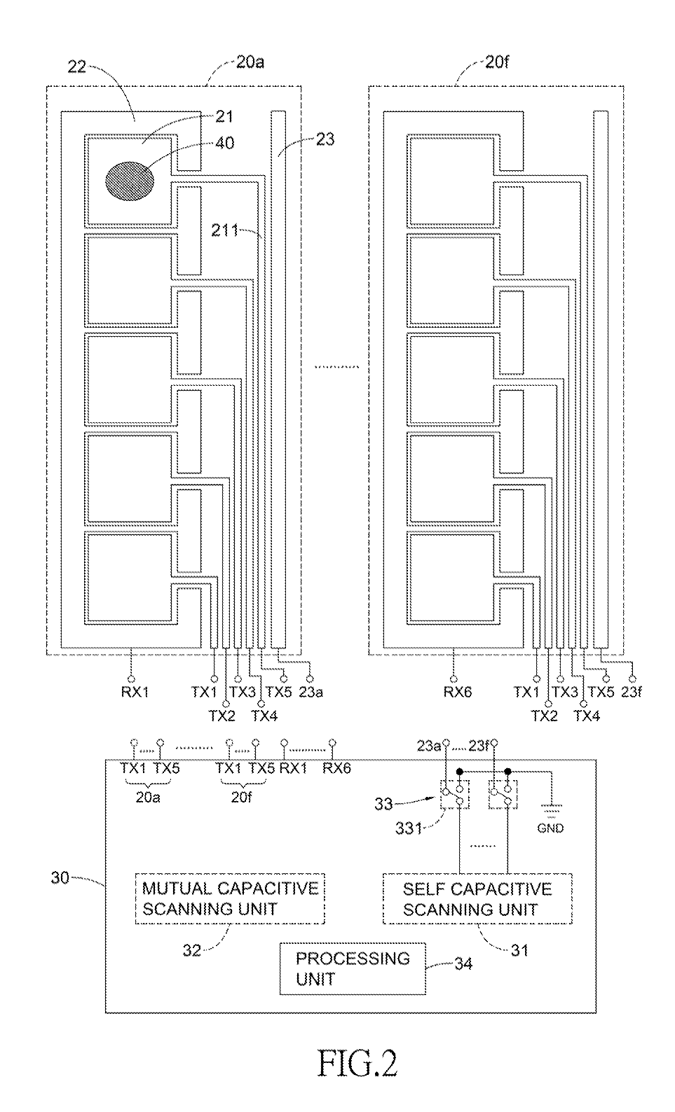

With reference to FIGS. 1 and 2, a structure of the signal layer capacitive touch panel is shown and the single layer capacitive touch panel has a substrate 10 and a controller 30. Multiple electrode groups 20a to 20f and multiple shielding units 23 are formed on a surface 101 of the substrate 10. Each of the shielding units 23 is formed between the two corresponding adjacent electrode groups 20a and 20b, 20b and 20c, 20c and 20d, 20d and 20e, 20e and 20f. Each of the electrode group 20a, 20b . . . , or 20f has n driving electrodes 21, n leading lines 211 and m sensing electrodes 22. The leading lines 211 are arranged in parallel and respectively connected to the driving electrodes 21. Each of the sensing electrodes 22 is formed adjacent to the n corresponding driving electrodes 21. In detail, the electrode groups 20a to 20f are arranged in parallel and along a first direction X, and the leading lines 211 and the shielding units 23 are also arranged in parallel and along the first direction X. Each of the shielding units 23 is formed a shape of a strip and has a width, which is the same as a width of each leading line 211. In another preferred embodiment, the width of the shielding unit 23 is different from that of the leading line 211. The shielding unit 23 is adjacent to one leading line 211 located outside of the electrode group 20a, 20b . . . or 20f. In the first embodiment, each of the electrode groups 20a, 20b . . . ,or 20f has the five driving electrodes 21 (n=5) and the one sensing electrode 22 (m=1). The five driving electrodes 21 of each electrode group 20a, 20b . . . or 20f are arranged along a second direction Y. The sensing electrode 22 of each electrode group 20a, 20b . . . , or 20f surrounds the five corresponding driving electrodes 21 and has five openings 221. The five openings 221 respectively corresponds to the layout of the leading lines 211 of the driving electrodes 21, so the five leading lines 211 are respectively connected to the five driving electrodes 21 through the corresponding openings 221.

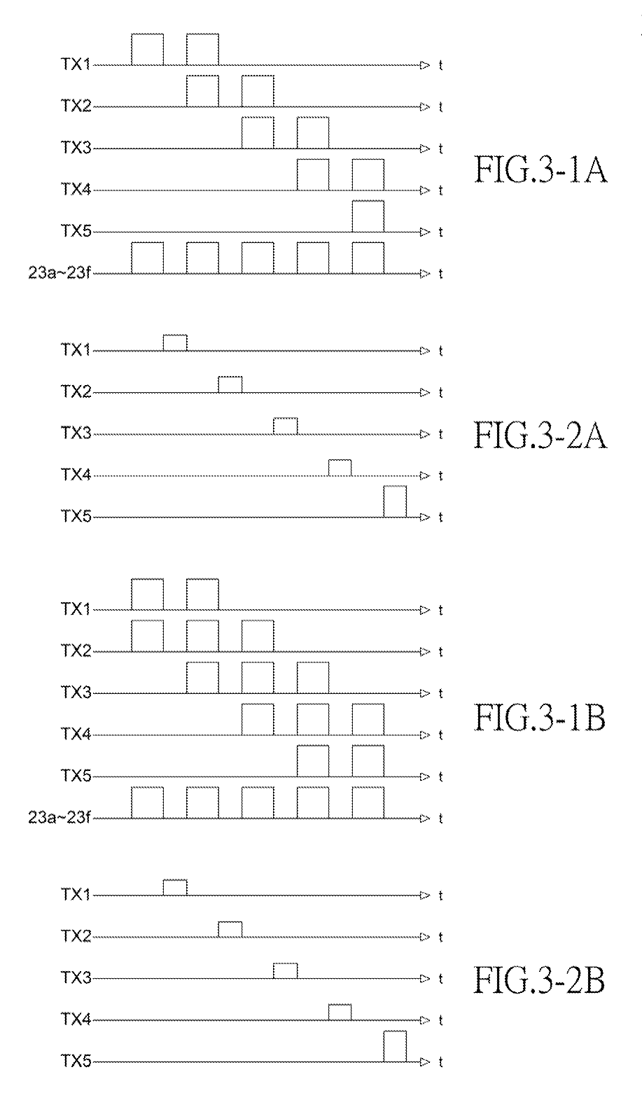

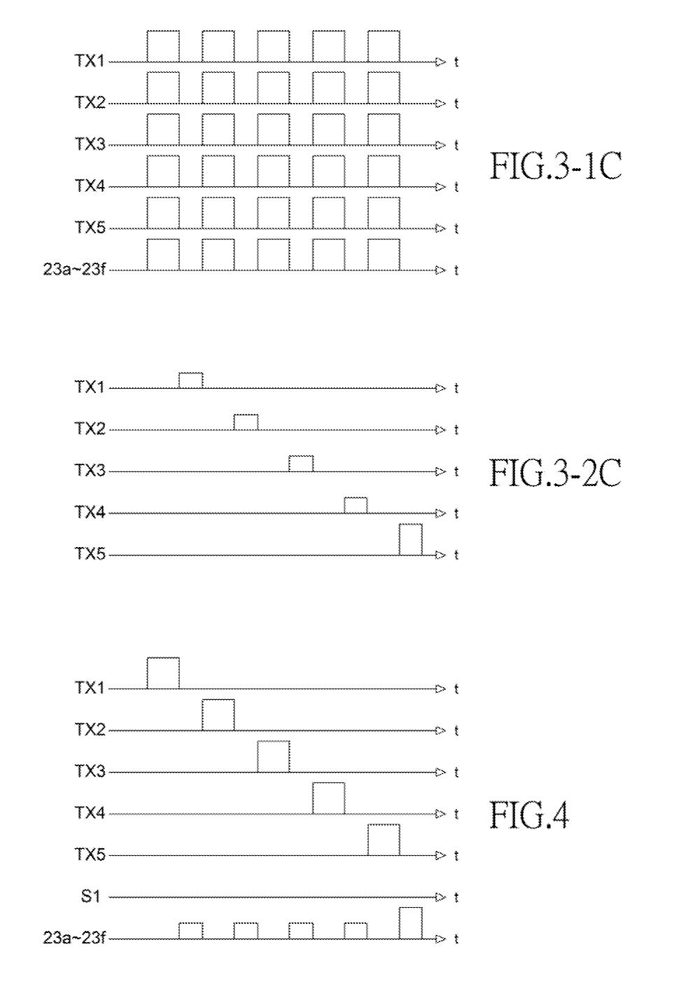

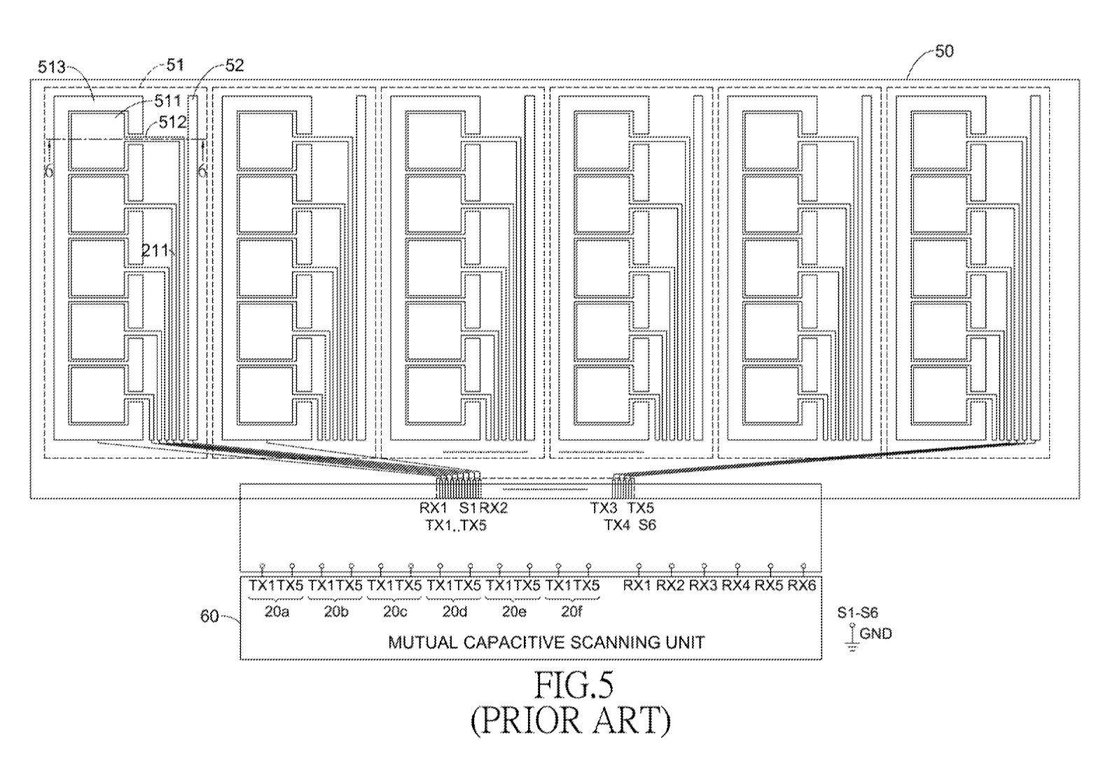

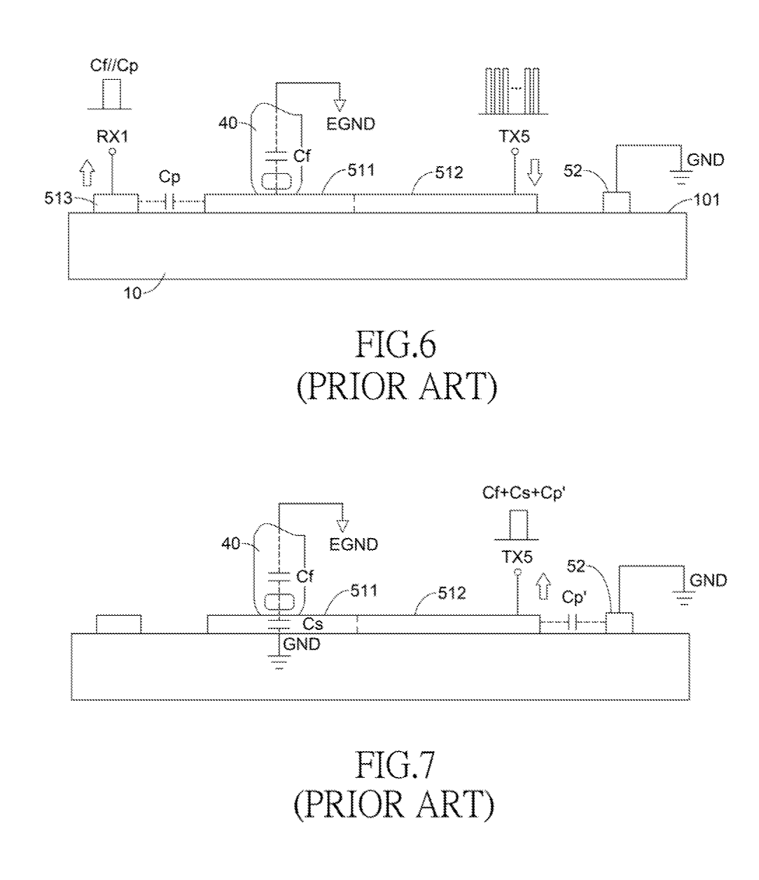

With reference to FIGS. 1 and 2, the controller 30 is connected to the leading lines 211 and the sensing lines 22 of the electrode groups 20a to 20f and the shielding units 23. The controller 30 also has a self capacitive scanning procedure. When the controller 30 executes the self capacitive scanning procedure, a first driving signal is outputted to the electrode group 20a˜20f, with further reference to FIG. 3-1A, the first driving signal is also synchronously outputted to the shielding units 23a˜23f. A self capacitive sensing signal from the driven electrode group 20a, 20b . . . or 20f is received after outputting the first driving signal. The controller 30 further has a mutual capacitive scanning procedure. When the controller 30 executes the mutual capacitive scanning procedure, a second driving signal is outputted to the electrode groups 20a˜20f, with further reference to FIG. 4, the controller 30 controls the shielding units 23a˜23f to connect to a ground GND. A mutual capacitive sensing signal from the driven electrode group 20a˜20f is received after outputting the second driving signal. A voltage of the first driving signal is lower than that of the second driving signal. In another preferred embodiment, the voltage, frequency and phase of the first driving signal may be same as those of the second driving signal.

With reference to FIG. 2, the controller 30 has a self capacitive scanning unit 31, a mutual capacitive scanning unit 32, s switching unit 33 and a processing unit 34. The processing unit 34 is connected to the self capacitive scanning unit 31, the mutual capacitive scanning unit 32 and the switching unit 33. When the processing unit 34 executes the self capacitive scanning procedure, the self capacitive scanning unit 31 selectively connects to the n leading lines 211. When the processing unit 34 executes the mutual capacitive scanning procedure, the mutual capacitive scanning unit 32 selectively connects to the n leading lines 211 and m sensing electrodes 22 of each electrode group 20a˜20f. The switching unit 33 switches the shielding units 23a˜23f to connect to the self capacitive scanning unit 31 or the ground GND.

In a preferred embodiment, the switching unit 33 has m multiple switches 331, and the m shielding units 23a to 23f are respectively connected to the self capacitive scanning unit 31 or the ground GND through the multiple switches 331. When the processing unit 34 executes the self capacitive scanning procedure, the controller 30 controls the switches 331 of the switching unit 33 to switch the shielding units 23a to 23f to connect to the self capacitive scanning unit 31. The self capacitive scanning unit 31 outputs the first driving signal to the shielding units 23a to 23f as shown in FIGS. 3-1A, 3-1B and 3-1C. When the processing unit 34 executes the mutual capacitive scanning procedure, the mutual capacitive scanning unit 32 outputs the second driving signal and the processing unit 34 controls the switches 331 of the switching unit 31 to switch one or more of the shielding units 23a to 23f to connect to the ground GND, as shown in FIG. 4.

With reference to FIGS. 2 and 3-1A, the processing unit 34 of the controller 30 executes a first type of the self capacitive scanning procedure. Using the first electrode group 20a as an example, the processing unit 34 controls the self capacitive scanning unit 31 to output the first driving signal to the leading line 211 of the k^{th} driving electrode 21 and the leading line 211 of the (k−1)^{th} driving electrode 21 and the shielding unit 23a adjacent to the electrode group 20a, wherein 1<k≦n. The self capacitive scanning unit 31 only receives the self capacitive sensing signal of the k^{th} driving electrode 21 after outputting the first driving signal. TX1 to TX5 respectively represent the five driving electrodes 21 of the first electrode group 20a, hereafter. In another words, to obtain the self capacitive sensing signal of the k^{th} driving electrode TX5 (k=5), the first driving signal is outputted to the k^{th} and (k−1)^{th} driving electrodes TX4, TX5 and the shielding unit 23a at the same time, as shown in FIG. 3-1A. With reference to FIGS. 1 and 3-1A, each of the electrode groups 20a, 20b . . . or 20f has five driving electrodes (n=5). In order to receive the self capacitive sensing signal (k=5) of the fifth driving electrode TX5 of the first electrode group 20a, the processing unit 34 controls the self capacitive scanning unit 31 outputs the first driving signal to the fourth and fifth driving electrodes TX4, TX5 and the shielding unit 23a adjacent to the leading line 211 of the fifth driving electrode TX5. Since an electric potentials of the leading line 211 of the fifth driving electrode TX5 and the fifth driving electrode TX5 are equal to those of the leading line 211 of the fourth driving electrode TX4 and the fourth driving electrode TX4, and equal to that of the shielding unit 23a, the received self capacitive sensing signal from the fifth driving electrode TX5 does not include a first coupling capacitance between the leading line 211 of the fifth driving electrode TX5 and the leading line 211 of the fourth driving electrode TX4 and a second coupling capacitance between the leading line 211 of the fifth driving electrode TX5 and the shielding unit 23a. With reference to FIGS. 2 and 3-2A, the self capacitance value of the self capacitive sensing signal of the fifth driving electrode TX5 is greater than that of other driving electrode TX1,TX2, TX3 or TX4, when a touch object 40 touches the fifth driving electrode TX5 of the first electrode group 20a.

With further reference to FIGS. 2 and 3-1B, the processing unit 34 of the controller 30 executes a second type of the self capacitive scanning procedure. Using the first electrode group 20a as an example and in order to obtain the self capacitive sensing signal of the k^{th} driving electrode, the first driving signal is outputted to the (k−1)^{th}, k^{th} and (k+1)^{th} driving electrodes 21 and the shielding unit 23a at the same time, wherein 1<k≦n. TX1 to TX5 respectively represent the five driving electrodes 21 of the first electrode group 20a, hereafter. In a case, to receive the self capacitive sensing signal (k=4) of the fourth driving electrode TX4 of the first electrode group 20a, the first driving signal is outputted to three driving electrodes TX3, TX4 and TX5 and the shielding unit 23a. Each of the electrode groups 20a, 20b . . . or 20f has 5 driving electrodes (n=5). In another case, to receive the self capacitive sensing signal (k=5) of the fifth driving electrode TX5 of the first electrode group 20a, the first driving signal is only outputted to the fourth driving electrode TX4, the fifth driving electrode TX5 and the shielding unit 23a adjacent to the fifth driving electrode TX5 at the same time since the leading line 211 of the fifth driving electrode TX5 is adjacent to the shielding unit 23a. Since the electric potentials of the leading line 211 of the fifth driving electrode TX5 and the fifth driving electrode TX5 are equal to those of the leading line 211 of the fourth driving electrode TX4 and the fourth driving electrode TX4, and equal to that of the shielding unit 23a, the received self capacitive sensing signal does not include a first coupling capacitance between the leading line 211 of the fifth driving electrode TX5 and the leading line 211 of the fourth driving electrode TX4 and a second coupling capacitance between the leading line 211 of the fifth driving electrode TX5 and the shielding unit 23a. With reference to FIGS. 2 and 3-2B, the self capacitance value of the self capacitive sensing signal of the fifth driving electrode TX5 is greater than that of other driving electrode TX1, TX2, TX3 or TX4, when the touch object 40 touches the fifth driving electrode TX5 of the first electrode group 20a.

With reference to FIGS. 2 and 3-1C, the processing unit 34 of the controller executes a third type of the self capacitive scanning procedure. TX1 to TX5 respectively represent the five driving electrodes 21 of the first electrode group 20a, hereafter. To obtain the self capacitive sensing signal from any one of the driving electrodes, the self capacitive scanning unit 31 outputs the first driving signal to all of the driving electrodes TX1˜TX5 of the first driving group 20a and shielding unit 23a. As a result, the electric potentials of the k^{th} driving electrode 21 and the leading line 211 thereof are equal to those of the other driving electrodes 21 and the leading lines 211 thereof and is equal to that of the shielding unit 23a. The self capacitance value of the received self capacitive sensing signal of the k^{th} driving electrode 21 does not include the coupling capacitances among the k^{th} driving electrode 21, each of the other driving electrodes 21 and the shielding unit 23a. With reference to FIG. 3-2C, the self capacitance value of the self capacitive sensing signal of the fifth driving electrode TX5 is greater than that of other driving electrode TX1, TX2, TX3 or TX4, when the touch object touches the fifth driving electrode TX5 of the first electrode group 20a.

With reference to FIGS. 2 and 4, the processing unit 34 of the controller 30 executes the mutual capacitive scanning procedure. The mutual capacitive scanning unit 32 outputs the second driving signal to the driving electrodes 21 of each of the electrode groups 20a to 20f in sequence. When the second driving signal is outputted to one of the driving electrodes 21, which is going to be driven, a mutual capacitive sensing signal is received from the sensing electrode 22 of the driven driving electrode 21. During the mutual capacitive scanning procedure, the processing unit 34 controls the switching unit 33 to switch the shielding units 23a˜23f to connect to the ground GND. The touch object 40 touches the fifth driving electrode TX5 of the first electrode group 20a, the mutual capacitance value of the received mutual capacitive sensing signal from the sensing electrode 22 of the first electrode group 20a is increased after the second driving signal is outputted to the fifth driving electrode TX5. As a result, the greater mutual capacitance value of the received mutual capacitance is used to identify the position of the touch object 40 is located on the fifth driving electrode TX5 of the first electrode group 20a.

Based on the foregoing description, the scanning method has a self and mutual capacitive scanning procedures. When the self capacitive scanning procedure is executed, the controller outputs the first driving signal to drive the electrode group and also outputs the first driving signal to the shielding unit adjacent to the driven electrode group, and then the self capacitive sensing signal of the driven electrode group is received. When the mutual capacitive scanning procedure is executed, the controller outputs the second driving signal to drive the electrode group, which is going to be driven and connects the shielding unit adjacent to the electrode group to the ground, and then a mutual capacitive sensing signal of the driven electrode group is received. As a result, coupling signals between two adjacent electrode groups are shielded by the shielding unit, which is connected to the ground during executing the mutual capacitive scanning procedure. The self capacitive sensing signal does not include the coupling capacitances between the leading line of the driven driving electrode and the shielding unit, since the first driving signal is outputted to the driving electrode and the shielding unit at the same time during executing the self capacitive scanning procedure. The self capacitance value of the self capacitive sensing signal is not increased greatly since the shielding units are not connected to the ground. Therefore, the present invention provides a scanning method and device of a single layer capacitive touch panel to correctly identify a position of a touch object during a self capacitive scanning procedure or a mutual capacitive scanning procedure. In addition, a receiving circuit of a self capacitive scanning circuit is not changed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A scanning method of a single layer capacitive touch panel, which has multiple electrode groups and multiple shielding units respectively formed between the two corresponding adjacent electrode groups, and a controller is electrically connected to the electrode groups and the shielding units, and each of the electrode groups has n driving electrodes, n leading lines respectively connected to the n driving electrodes and at least one sensing electrode formed adjacent to the n corresponding driving electrodes, comprising a self capacitive scanning procedure and a mutual capacitive scanning procedure, wherein:
when the self capacitive scanning procedure is executed, the controller outputs a first driving signal to each of the electrode groups and each of the shielding units at the same time, and then receives a self capacitive sensing signal from each of the driven electrode group; and
when the mutual capacitive scanning procedure is executed, the controller outputs a second driving signal to each of the electrode groups and controls the shielding units to connect to a ground, and then receives a mutual capacitive sensing signal from the driven electrode groups.

2. The scanning method as claimed in claim 1, wherein when the self capacitive scanning procedure is executed, the controller outputs the first driving signal to the leading lines of the k^{th} and (k−1)^{th} driving electrodes of each of the electrode groups at the same time, and then receives the self capacitive sensing signal from the k^{th} driving electrode of each of the driven electrode groups, wherein 1<k≦n.

3. The scanning method as claimed in claim 2, wherein when the self capacitive scanning procedure is executed, the controller outputs the first driving signal to the leading lines of the k^{th} and (k+1)^{th} driving electrodes, and then receives the self capacitive sensing signal from the k^{th} driving electrode of each of the driven electrode groups, wherein 1<k≦n.

4. The scanning method as claimed in claim 1, wherein when the self capacitive scanning procedure is executed, the controller outputs the first driving signal to the n leading lines of each of the electrode groups and each of the shielding units, and then receives the self capacitive sensing signal from each of the driving electrodes.

5. The scanning method as claimed in claim 1, wherein a voltage of the first driving signal is lower than that of the second driving signal.

6. The scanning method as claimed in claim 1, wherein an electric potential, frequency and phase of the first driving signal are the same as those of the second driving signal.

7. A scanning device of a signal layer capacitive touch panel, comprising:
a substrate has multiple electrode groups and multiple shielding units, wherein each of the shielding units is formed between the two corresponding adjacent electrode groups and each of the electrode groups has n driving electrode, n leading lines arranged in parallel and respectively connected to the n driving electrodes and at least one sensing electrode; and
a controller electrically connected to the electrode groups and the shielding units and having a self capacitive scanning procedure, wherein when the controller executes the self capacitive scanning procedure, the controller outputs a first driving signal to each of the electrode groups and the shielding units at the same time, and then receives a self capacitive sensing signal from each of the driven electrode groups.

8. The scanning device as claimed in claim 7, the controller further comprises a mutual capacitive scanning procedure and when the controller executes the mutual capacitive scanning procedure, the controller outputs a second driving signal to each of the electrode groups and controls each of the shielding units to connect to a ground, and then receives a mutual capacitive sensing signal from each of the driven electrode groups.

9. The scanning device as claimed in claim 8, the controller further comprises:
a self capacitive scanning unit selectively switched to connect to the n leading lines;
a mutual capacitive scanning unit selectively switched to the n leading lines and the m sensing electrodes;
a switching unit connected to the shielding units and selectively switched to connect to the self capacitive scanning unit or the ground; and
a processing unit connected to the self capacitive scanning unit, the mutual capacitive scanning unit and the switching unit, wherein:
when the processing unit executes the self capacitive scanning procedure, the switching unit switches the shielding units to connect to the self capacitive scanning unit so that the self capacitive scanning unit outputs the first driving signal to each of the shielding units; and
when the processing unit executes the mutual capacitive scanning procedure, the mutual capacitive scanning unit outputs the second driving signal and the switching unit switches the shielding units to connect to the ground.

10. The scanning device as claimed in claim 9, wherein when the processing unit executes the self capacitive scanning procedure, the self capacitive scanning unit outputs the first driving signal to the leading lines of the k^{th} and (k−1)^{th} driving electrodes of each of the electrode groups at the same time, and then receives the self capacitive sensing signal from the k^{th} driving electrode of each of the driven electrode groups, wherein 1<k≦n.

11. The scanning device as claimed in claim 10, wherein when the processing unit executes the self capacitive scanning procedure, the self capacitive scanning unit outputs the first driving signal to the leading lines of the k^{th} and (k+1)^{th} driving electrodes, and then receives the self capacitive sensing signal from the k^{th} driving electrode of each of the driven electrode groups, wherein 1<k≦n.

12. The scanning device as claimed in claim 9, wherein when the processing unit executes the self capacitive scanning procedure, the self capacitive scanning unit outputs the first driving signal to the n leading lines of each of the electrode groups and each of the shielding units, and then receives the self capacitive sensing signal from each of the driving electrodes.

13. The scanning device as claimed in claim 8, wherein a voltage of the first driving signal is lower than that of the second driving signal.

14. The scanning device as claimed in claim 8, wherein an electric potential, frequency and phase of the first driving signal are the same as those of the second driving signal.
